(19) United States
(12) Patent Application Publication
(10) Pub. No.: US 2004/0039463 A1
(43) Pub. Date: Feb. 26, 2004

(54) Digital audio production device

(76) Inventors: Steve Sucher, Redondo Beach, CA (US); Gary Collins, Redondo Beach, CA (US); Mari Bower, Redondo Beach, CA (US); Craig Stock, Torrance, CA (US)

Correspondence Address: KOLISCH HARTWELL, P.C., 520 S.W. YAMHILL STREET, SUITE 200, PORTLAND, OR, 97204, US

(21) Appl. No.: 10/434,438

(22) Filed: May 6, 2003

Related U.S. Application Data
(60) Provisional application No. 60/378,580, filed on May 6, 2002.

(51) Int. Cl. G06F 17/00; H04B 1/00

(52) U.S. Cl. 700/94; 381/119

(57) ABSTRACT

A portable digital audio device sized and shaped for handheld operation. The device includes a digital music production system for mixing and editing audio content acquired by the device. A mixing system is configured to audibly combine two or more audio clips that have been acquired by the device. An editing system is configured to alter an acoustic attribute of an audio clip that has been acquired by the device. The device also may include a portable power supply configured to provide power to the device. A housing at least partially encloses the mixing system, editing system, and power supply.

### CROSS-REFERENCE TO RELATED APPLICATIONS

This application claims priority under 35 U.S.C. § 119(e) from the following co-pending provisional patent application, which is incorporated herein by this reference, in its entirety and for all purposes: PORTABLE DIGITAL DEVICE FOR INPUTTING, MIXING, EDITING AND OUTPUTTING AUDIO CONTENT, Serial No. 60/378,580, filed May 6, 2002.

### BACKGROUND

Producing high quality audio content recordings has traditionally been an expensive and time consuming endeavor. Such producing has typically been performed in specialized studios or audio laboratories, which are equipped with specialized and expensive equipment for recording, mixing, and editing music. However, most people do not have access to such studios, and therefore have not been able to produce recordings with high quality audio content. Furthermore, people that do have access to such studios often desire to mix and edit audio content away from the studio.

### SUMMARY

A portable digital audio device sized and shaped for handheld operation is provided. The device includes a digital music production system for mixing and editing audio content acquired by the device. A mixing system is configured to audibly combine two or more audio clips that have been acquired by the device. An editing system is configured to alter an acoustic attribute of an audio clip that has been acquired by the device. The device also may include a portable power supply configured to provide power to the device. A housing at least partially encloses the mixing system, editing system, and power supply.

### BRIEF DESCRIPTION OF THE DRAWINGS

FIG. 1 is a schematic block diagram of a digital audio device configured for portable handheld use.

FIG. 2 is a top view of an exemplary digital audio device having a housing configured for handheld operation.

FIG. 3 is a bottom view of the digital audio device of FIG. 2.

FIG. 4 is a side view of the digital audio device of FIG. 2.

### DETAILED DESCRIPTION

The present disclosure is directed to a portable digital audio device configured for handheld operation. As used herein, “portable” means that the device may be easily carried by a variety of users, including children. Therefore, the disclosed device is typically no greater than two pounds and is sized for easy transportation. In general, the disclosed device is no greater than twelve inches in any one dimension with a total volume less than thirty cubic inches, and preferably less than twenty-two cubic inches, although other sizes are within the scope of this disclosure. As used herein, “handheld” means that the device is configured to be operated while the device is held by a user's hands, as opposed to being supported by a table or other stand. Therefore, the controls are positioned where they may be easily accessed by a user's fingers while holding the device with one or two hands.

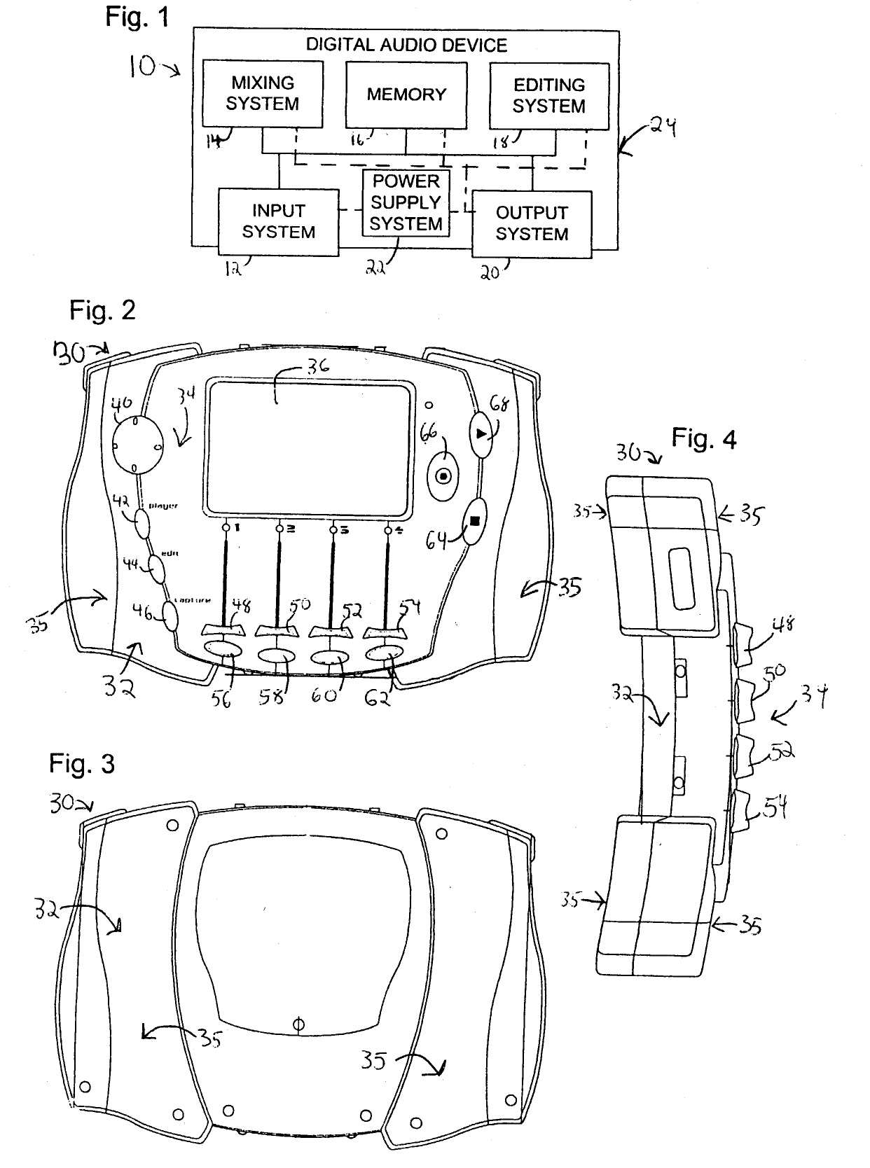

FIG. 1 schematically shows a portable digital audio device 10 that includes an input system 12, a mixing system 14, a memory 16, an editing system 18, an output system 20, and a power supply system 22. Input system 12, mixing system 14, editing system 18, and output system 20 may utilize one or more circuits, processors, and/or I/O interfaces configured to provide the functionality described below. The digital audio device also includes a housing 24, or case, that at least partially encloses the other components of the device. In other words, the size and shape of the housing at least substantially define the size and shape of the device. Portions of some components may extend outside of the housing, and some elements, such as buttons, switches, and dials for controlling the device may be positioned adjacent the housing, where they may be accessed by a user.

Input system 12 may be configured to record, or otherwise acquire, analog and/or digital audio content, including information, data, or signals, in the form of clips, or samples. A clip may be any length or portion of an audio work, including the entire work, or even a collection of several works. The input system may include an analog input jack, a microphone, a digital input, a radio receiver, or other mechanism for acquiring live and/or prerecorded audio content. For example, another audio device, such as an audio cassette player or a compact disc player, may be linked to input system 12 via an RCA cable, or other suitable signal conveyor or communication link. Audio content may be delivered from the other audio device to the input system in the form of an analog audio signal conveyed via the cable. In some embodiments, a built-in or external microphone may supply the input system with audio content. In some embodiments, an input button, such as a beat-generation button, may be configured to supply the input system with audio content. The above are provided as nonlimiting examples.

Input system 12 may include analog-to-digital converters for converting analog audio content into digital audio content, which may be at least temporarily stored in memory 16 and/or processed, such as by mixing or editing. The sampling rate and bit depth may be selected to yield a desired level of quality and file size. Input system 12 may also include a data compressor for reducing the amount of memory required to hold digital audio content. Lossless or lossy data compressors may be used, and the compressors may be configured to generate digital audio data in a desired format. Nonlimiting examples of suitable formats include WAV, AIFF, MP3, and AAC.

A memory 16 may be configured to at least temporarily store audio content in the form of digital audio data. The memory is operatively coupled to the input system, and configured to receive digital audio data therefrom. Memory 16 may be selected to provide a desired balance of cost, memory capacity, memory speed, and energy efficiency. Memory 16 may include volatile and/or nonvolatile portions.

Digital audio device 10 is designed for portable handheld operation. Memory 16 may include semiconductor memory portions, which may be well suited for portable use because there are no moving parts and little opportunity for the memory to “skip.” However, magnetic and/or optical memory portions may also be used, and may be beneficial because of relatively low costs and fast read and/or write speeds. Such technologies may cooperate with a buffer portion, such as a semiconductor memory buffer, to reduce the likelihood of memory skips.

As mentioned, portable digital audio device 10 includes mixing system 14 and editing system 18, which may be used to generate produced audio tracks based on one or more input audio clips. Mixing system 14 audibly combines two or more audio clips together as a mixed audio track. The audio clips may be retrieved from memory 16 and/or received directly from input system 12. Mixing system 14 may mix an unedited clip stored in memory and/or a clip that has been edited, such as by editing system 18. Clips may be mixed in their entirety, or selected portions of the clips may be audibly combined together.

As used herein, “audibly combined” means a portion of one audio clip is linked with another portion of the same or a different audio clip. In other words, the constituent clips that make up the mixed track are effectively joined together, at least from the perspective of a user listening to a mixed track. A mixed track may be selected for playback as a single entity. During playback, a mixed track plays the selected portions as determined by the linkage established during mixing. A mixed track may also be saved into memory 16 for later playback and or sharing. In some embodiments a mixed track may include a data file with instructions detailing how to combine two or more clips. In some embodiments, the mixing system may be used to create a real-time mix, in which the output system plays the mixed track while the mix is being produced by a user. In such embodiments, the mixed track may be saved into memory, although this is not required.

Mixed tracks may be arranged so that the constituent audio clips are arranged as a layered track, in which selected portions of two or more tracks are arranged for simultaneous playback, and/or as a linear track, in which a portion of one clip follows a portion of another clip. Mixed tracks may also include looped portions, in which the same segment of audio content is repeated two or more times. A produced track may include linear, layered, and looped portions. The relative volume of the constituent clips may be automatically adjusted and/or manually adjusted. For example, the output level of two or more clips may be automatically matched or a user may adjust a clip's volume using a fader or other suitable control.

Mixing system 14 may synchronize the beat of two or more clips so that the respective beats from the clips automatically synchronize with one another. In other words, the mixing system may automatically adjust the tempo of a clip to correspond with the tempo of another clip when mixing the clips into a produced track. Such synchronization may facilitate an illusion that a mixed track is professionally produced, resulting in high-quality audio content. Even though constituent clips of a mixed track may initially have different tempos, tempo synchronization may be used to combine the clips in a sonically pleasing manner, which would not occur if the tracks had mismatched tempos.

Editing system 18 audibly alters an acoustic attribute of an audio clip and/or track to generate an edited track. In other words, the editing system may change the way a clip or track sounds. Such changes may be made in real-time during playback. In some embodiments, the changes may be made in virtual time, before playback. The changes may be effectuated by activating one or more user operable controls, including buttons, switches, dials, faders, and/or elements of a digital interface presented on a display. Digital audio data may be edited by digital filters, or algorithms, which are programmed to alter digital audio data to produce a desired effect. Such filters may be executed by a processor, application specific integrated circuit, or similar device, of the editing system. In the case of a programmable processor, new filters may be added to a device to facilitate new types of editing. The filters may be added as software and/or firmware updates. In some embodiments, the editing system may be configured to receive editing modules, which may be selectively coupled to the editing system to provide new editing functionality.

Edited tracks may be stored in memory 16, and subsequently played via the output system or shared by transferring the digital audio file embodying the edited audio content. Like mixed tracks, edited tracks may be stored as self contained files, which include all of the information necessary for playback. Edited tracks, as well as mixed tracks, may alternatively be saved as a set of instructions for altering another data file, such as the file of a constituent clip. In some embodiments, the produced track may not be saved.

Digital audio content may be edited to produce a variety of effects. Exemplary alterations include changing tempo and changing pitch. Some alterations may add or subtract selected portions of audio content. For example, sounds may be added to replicate a drum, bass, or other instrument. Selected portions of a clip or track, such as a baseline or the vocals, may be extracted. A portion extracted from one clip may be combined with a portion of another clip by the mixing system. Other exemplary editing effects include vocoding, in which audio content is layered with synthetic electronic sounds, for example making a human voice sound robotic or like a talking electric guitar. A scratch effect may be used to alter the sound of a track to mimic a scratch sound achieved when a pickup, or needle, scratches across a phonograph record. A reverb, or echo, effect may be used to cause a selected range of sounds to echo. These and other digital effects may be implemented to change the acoustic attributes of audio content in a desired manner.

Output system 20 generates audio-playback signals based on recorded audio clips and produced audio tracks, including mixed tracks, edited tracks, and edited mixed-tracks, which are tracks that have been both edited and mixed. The audio-playback signal may take the form of an electromagnetic signal that may be delivered via wired or wireless delivery mechanisms. The output system may include a digital-to-analog converter for converting digital audio data into analog audio-playback signals. The output system may also include a data decompressor configured to expand compressed digital audio data. Furthermore, the output system may include an amplifier for amplifying the signal. In some embodiments, the output system may include one or more speakers for converting the electromagnetic energy of the playback signal into sound energy. In some embodiments, the output system may include a radio signal generator for broadcasting audio-playback signals to other devices.

Portable digital audio device 10 includes a power supply system for delivering power to the various components that utilize the power to input, mix, edit, and output audio content. The power supply may be portable, meaning that it is self contained and capable of supplying power away from an electrical outlet or similar stationary power supply. To achieve portability, power supply 22 may include one or more batteries. Batteries, whether they are primary (single use) or secondary (rechargeable), are devices which convert chemical energy into electrical energy. Secondary batteries may be charged with electrical energy, which is stored as chemical energy for later use. Batteries may include cells with NiCd, NiMH, Lithium Ion, or other chemistries for storing chemical energy that may be released as electrical energy.

As described above, digital audio device 10 is configured for portable handheld operation. To simplify operation, housing 24 is sized and shaped to be held with one or two hands. The housing may include various controls for controlling operation of the device, such as input, editing, mixing, and playback. To facilitate handheld operation, such controls may be positioned where they may be easily manipulated by a user that is holding the device. For example, many of the controls may be thumb operable controls, which may be manipulated by a thumb while a user's fingers and palm support the device.

FIGS. 2-4 show an exemplary digital audio device 30 with a housing 32 sized to fit in a user's hands. Digital audio device 30 includes a control console 34, which in turn includes a plurality of user operable controls. Audio device 30 includes a grip region 35 configured to provide a comfortable and stable holding area for a user. Control console 34 may be positioned adjacent grip region 35 or at least partially overlap with grip region 35. As shown in the illustrated embodiment, control console 34 is adapted for handheld operation, with many of the individual controls positioned proximate the perimeter of the device's upper surface. It is within the scope of the invention to position controls in other locations, especially in other locations that are easily accessible when holding the device, such as locations proximate or overlapping a grip region.

In some embodiments, the digital audio device may include a display, such as display 36. A display may be used to present a user with additional and/or alternative control options via a menu or series of menus. Such control options may be selected by manipulating one or more physical controls, via a touch screen interface, or another suitable input mechanism.

In the illustrated embodiment, digital audio device 30 includes a multi-position selection switch 40, a player button 42, an edit button 44, a capture button 46, a first fader 48, a second fader 50, a third fader 52, a fourth fader 54, a first channel selector 56, a second channel selector 58, a third channel selector 60, a fourth channel selector 62, a stop button 64, a record button 66, and a play button 68. The placement of the controls facilitate handheld operation, allowing each control to be manipulated by one of a user's thumbs while the user supports the device from underneath with the user's fingers. Multi-position selection switch 40, player button 42, edit button 44, capture button 46, first fader 48, second fader 50, first channel selector 56, and second channel selector 58 are positioned for manipulation by a left thumb, while the other controls are positioned for use by a right thumb. The above is provided as a nonlimiting example of one possible housing and control arrangement.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

What is claimed is:

1. A portable digital audio device, comprising:
a memory;
an input system configured to load one or more audio clips in the memory;
a mixing system configured to access two or more audio clips from the memory and audibly combine the clips as a mixed track;
an output system configured to output the mixed track;
a portable power-supply system configured to deliver power to at least the mixing system; and
a portable housing sized for handheld operation and configured to at least partially enclose the portable power-supply system, the memory, the input system, the mixing system, and the output system.

2. The portable digital audio device of claim 1, wherein the housing substantially defines a volume no greater than approximately thirty cubic inches.

3. The portable digital audio device of claim 2, wherein the housing substantially defines a volume no greater than approximately twenty-two cubic inches.

4. The portable digital audio device of claim 1, further including a control console that includes a plurality of user manipulable controls positioned adjacent a grip region, wherein the user manipulable controls are operatively connected to at least one of the input system, the mixing system, the editing system, and the output system.

5. The portable digital audio device of claim 1, further including a control console that includes a plurality of user manipulable controls positioned around a perimeter of the housing, wherein the user manipulable controls are operatively connected to at least one of the input system, the mixing system, the editing system, and the output system.

6. The portable digital audio device of claim 1, further including a display configured to present at least one menu having a plurality of user selectable control options.

7. The portable digital audio device of claim 1, wherein the input system includes an analog input jack.

8. The portable digital audio device of claim 1, wherein the input system includes a microphone.

9. The portable digital audio device of claim 1, wherein the input system includes a digital input.

10. The portable digital audio device of claim 1, wherein the input system includes a radio receiver.

11. The portable digital audio device of claim 1, wherein the input system includes an analog-to-digital converter.

12. The portable digital audio device of claim 1, wherein the input system includes a data compressor.

13. The portable digital audio device of claim 1, wherein the memory includes semiconductor memory portions.

14. The portable digital audio device of claim 1, wherein the mixing system is configured to audibly combine two or more audio clips as a layered mixed-track.

15. The portable digital audio device of claim 14, wherein the mixing system is configured to synchronize the tempo of the audio clips that constitute the layered mixed-track.

16. The portable digital audio device of claim 1, wherein the mixing system is configured to audibly combine two or more audio clips as a looped mixed-track.

17. The portable digital audio device of claim 1, further comprising an editing system configured to alter an acoustic attribute of an audio clip to generate an edited track, wherein the output system is additionally configured to generate an audio-playback signal based on the edited track.

18. The portable digital audio device of claim 17, wherein the edited track is at least temporarily held in the memory.

19. The portable digital audio device of claim 17, wherein the editing system is configured to change a tempo of the audio clip to generate the edited track.

20. The portable digital audio device of claim 17, wherein the editing system is configured to change a pitch of the audio clip to generate the edited track.

21. The portable digital audio device of claim 17, wherein the editing system is configured to add selected portions of audio content to the audio clip to generate the edited track.

22. The portable digital audio device of claim 17, wherein the editing system is configured to subtract selected portions of audio content from the audio clip to generate the edited track.

23. The portable digital audio device of claim 17, wherein the editing system is configured to add vocode to selected portions of audio content in the audio clip to generate the edited track.

24. The portable digital audio device of claim 17, wherein the editing system is configured to digitally scratch selected portions of audio content in the audio clip to generate the edited track.

25. The portable digital audio device of claim 17, wherein the editing system is configured to apply reverb to selected portions of audio content in the audio clip to generate the edited track.

26. The portable digital audio device of claim 1, wherein the portable power-supply includes a battery.

27. A portable digital audio device, comprising:
a digital music production system including:
means for inputting a first audio signal and a second audio signal;
means for mixing the first audio signal with the second audio signal to generate a mixed audio signal; and
means for playing the mixed audio signal;
a portable power supply configured to deliver power to the digital music production system; and
a portable housing sized for handheld operation and configured to at least partially enclose the digital music production system.

28. The portable digital audio device of claim 27, wherein the digital music production system further includes means for editing the audio signal to generate an edited audio signal and means for generating an audio-playback signal based on the edited audio signal.

29. The portable digital audio device of claim 27, further comprising a control console that includes a plurality of user manipulable controls operatively connected to the digital music production system and configured to control the digital music production system.

30. The portable digital audio device of claim 29, wherein the portable housing includes a grip region configured to be held by a user, and wherein the control console is positioned proximate the grip region.

31. The portable digital audio device of claim 29, wherein the portable housing includes a grip region configured to be held by a user, and wherein the control console and the grip region are aligned so that a user's thumb is in position to manipulate the control console when the user's hand is holding the grip region.

32. A portable digital audio device, comprising:
a digital music production system including:
a memory;
an input system configured to at least temporarily load one or more audio clips in the memory;
a mixing system configured to access two or more audio clips from the memory and audibly combine the clips as a mixed track; and
an output system configured to output the mixed track;
a portable housing sized for handheld operation and configured to at least partially enclose the digital music production system; and
a control console that includes a plurality of user manipulable controls operatively connected to the digital music production system and configured to control the digital music production system;
wherein the portable housing includes a grip region configured to be held by at least a user's fingers while positioning a user's thumb proximate a control of the control console.
